(19) United States
(12) Patent Application Publication
(10) Pub. No.: US 2006/0201243 A1
(43) Pub. Date: Sep. 14, 2006

(54) Ocean bottom floor hydrophones and seismometers

(76) Inventors: Yves Auffret, Plougonvelin (FR); Pascal Pelleau, Landerneau (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/530,154

(22) PCT Filed: Oct. 1, 2003
(86) PCT No.: PCT/FR03/02875

§ 371 Date: Apr. 1, 2005

(30) Foreign Application Priority Data
Oct. 2, 2002 (FR) 02/12159

(51) Int. Cl. G01C 13/00

(52) U.S. Cl. 73/170.29

(57) ABSTRACT

The invention concerns an ocean bottom station, such as an ocean bottom hydrophone (OBH) or an ocean bottom seismometer (OBS), designed to perform in situ measurements, comprising a support structure with positive buoyancy where-with is associated at least on detachable ballast to bring said support structure to the ocean bottom during a measurement session, the support structure including at least one hydrophone, one data acquisition unit for recording measurement data from the hydrophone and a device for releasing said detachable ballast. The invention is characterized in that the data acquisition unit serves to control the releasing device in response to an acoustic release command received by the hydrophone.

The present invention relates to devices of the type comprising a hydrophone and an associated data acquisition unit, designed to be left on the ocean bottom for the time of a measurement session in order to be then retrieved on the surface. It relates more particularly to such devices known as ocean bottom hydrophones (OBH) and ocean bottom seismometers (OBS).

Such devices are used to implement methods for the exploration of the deepest layers of the earth's crust, especially in the context of petroleum exploration. The devices are placed on the ocean bottom, after which a sonic wave is emitted at regular intervals from the surface. The recording of the response from the ocean bottom to this acoustic wave is used to determine the disposition of the geological layers and interpret, for example, their nature. The measured data can also be used to determine the past and foresee future development.

Ocean-bottom hydrophones (OBH) are used to record sound waves propagated from the surface up to the sub-bottom layers. The measured waves come from reflection and/or refractions on the layers.

Ocean-bottom seismometers (OBS) are identical to hydrophones (OBH) but, instead of or as a complement to the hydrophone proper, they have at least one seismic sensor called a geophone to detect the shear waves, thus making it possible especially to determine the fluid content of the sub-bottom.

By its very conception, an ocean bottom hydrophone or seismometer (which shall also be called an ocean bottom seismic station here below) is completely independent. When released, it therefore needs negative buoyancy in order to descend to the bottom of the water. Once in position, it measures the acoustic waves in the frequency band for which it is programmed. At the end of the operation, a particular acoustic command is used to control a mechanism that again gives positive buoyancy to the apparatus so that it rises to the surface where it will be retrieved. This positive buoyancy is generally obtained by the releasing of a ballast.

In practice, a device of this type, as disclosed for example in the document WO 93/05411 therefore essentially comprises a support structure having positive buoyancy with which a detachable ballast is associated, the support structure containing the measurement sensors, hydrophone and geophones, the data acquisition unit that is associated with them, a ballast-releasing set, an electrical power supply block and several other secondary pieces of equipment used for surface retrieval, such as a VHF transmitter and its antenna, and a light source. Both the data acquisition unit and the set for controlling the release of the ballast, which are distinct units, are protected as required for very deep immersion.

Furthermore, the ballast-releasing set and its control units must be perfectly reliable. This particular point is dealt with in the U.S. Pat. No. 4,446,537. This patent describes a very complex and redundant releasing system by which the release function can be performed in any circumstance. To this end, the release set has its own electronic circuitry and comprises especially a transducer to receive an acoustic release command coming from the surface.

The main drawback of these devices is that they are bulky and costly owing to the sophistication of their various elements.

Now, in measurement techniques, the future trend is toward the implementation of methods involving the deployment of large numbers of ocean-bottom seismic stations especially to improve the spatial distribution of the measurement and hence the accuracy of the interpretations.

This means that it is necessary to consider operating, for example, with 50 to 70 stations for which a single ship would provide the transport and the releasing and, after the sending of the measurement sound waves, the retrieval. Given the cost and the space required by existing stations, this is presently unrealistic.

Thus, the invention results from some thought devoted to this problem, oriented toward the designing of ocean bottom seismic stations (OBH and OBS) that are less costly, more compact, and therefore easier to handle, while at the same time being reliable with respect to being raised to the surface and performing efficiently as regards measurement.

According to the invention, it is planned to use only one electronic unit common to the acquisition of data from the measurement sensors and to the control of the ballast-releasing mechanism, and to use the measurement hydrophone to receive the ballast-releasing command coming from the surface.

Thus, the invention relates to an ocean-bottom station designed to make in situ measurements comprising a support structure with positive buoyancy with which there is associated at least one detachable ballast to convey said support structure to the bottom of the ocean for the period of a measurement session, the support structure including at least one hydrophone, one data acquisition unit to record measurement data and one device for the releasing of said detachable ballast, characterized in that the data acquisition unit is furthermore capable of controlling the releasing device in response to an acoustic release command received by the hydrophone.

The release command is preferably a low-frequency acoustic signal modulated by a carrier signal having, for example, a frequency of 8 to 12 KHz.

According to a preferred embodiment, the low-frequency acoustic signal comprises a plurality of consecutive elementary signals of a first type and of a second type representing a sequence of bits proper to said seismic station, the elementary signals of the first type and of the second type respectively representing bits with a value 0 and bits with a value 1, or vice versa. The elementary signals of the first type are, for example, signals that are linearly modulated in frequency from the frequency f1 to the frequency f2, with f2>f1, and the elementary signals of the second type are signals linearly modulated in frequency from the frequency f2 to the frequency f1, or vice versa.

To detect a release command in the signal received by the hydrophone, the data-acquisition unit comprises means to sample said received signal and detection means to detect the presence of the low-frequency signal in the sampled signal by digital correlation and deliver a release command to the releasing mechanism if said low-frequency signal is detected.

Furthermore, the support structure of the station is constituted by a spherical glass enclosure placed inside a protection shell, said spherical enclosure being resistant to the hydrostatic pressure present at depths that may go up to several thousands of meters. The ballast is attached to the support structure by elastic cords that are fixed, by a first end, to said ballast and, by a second end, to a metal ring destructible by electrolysis.

The releasing mechanism comprises a switch controlled by the detection means of the data acquisition unit. When it receives a release command, the switch makes an electrical current pass into the metal ring to destroy it and release the ballast.

Other features and advantages of the invention shall appear from the following detailed description, made with reference to the appended dryness, of which:

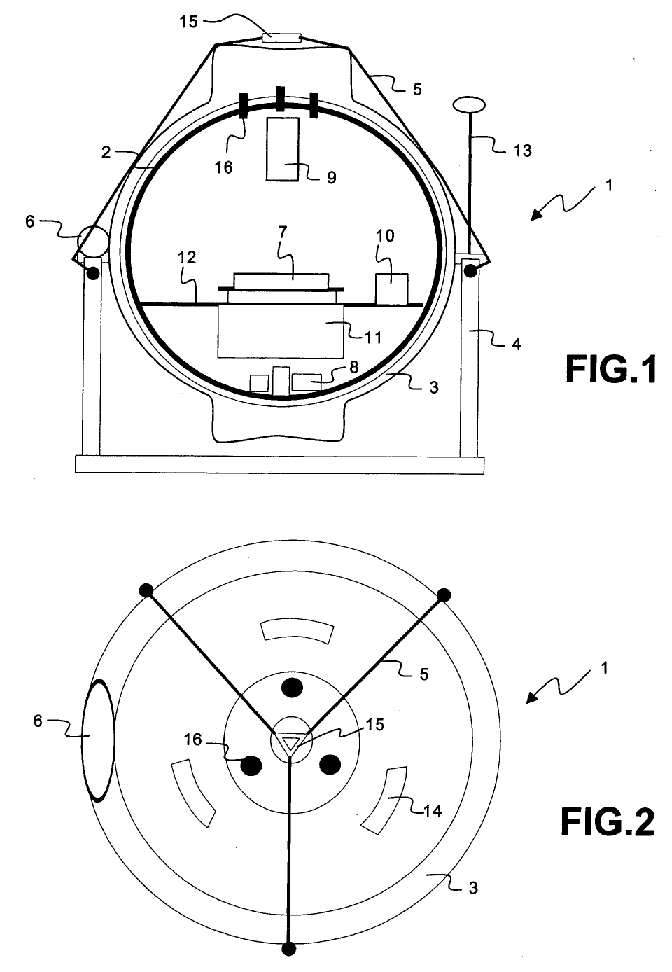

FIG. 1 is a schematic of view in section of an ocean-bottom seismic station according to the invention;

FIG. 2 is a top view of the ocean-bottom seismic station of FIG. 1;

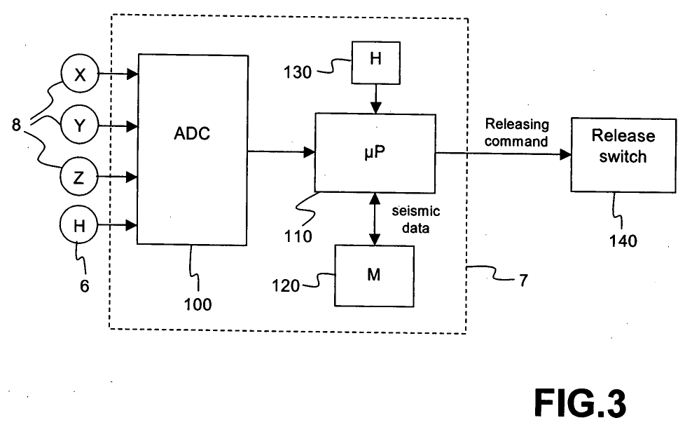

FIG. 3 exemplifies an embodiment of a data acquisition and release command unit;

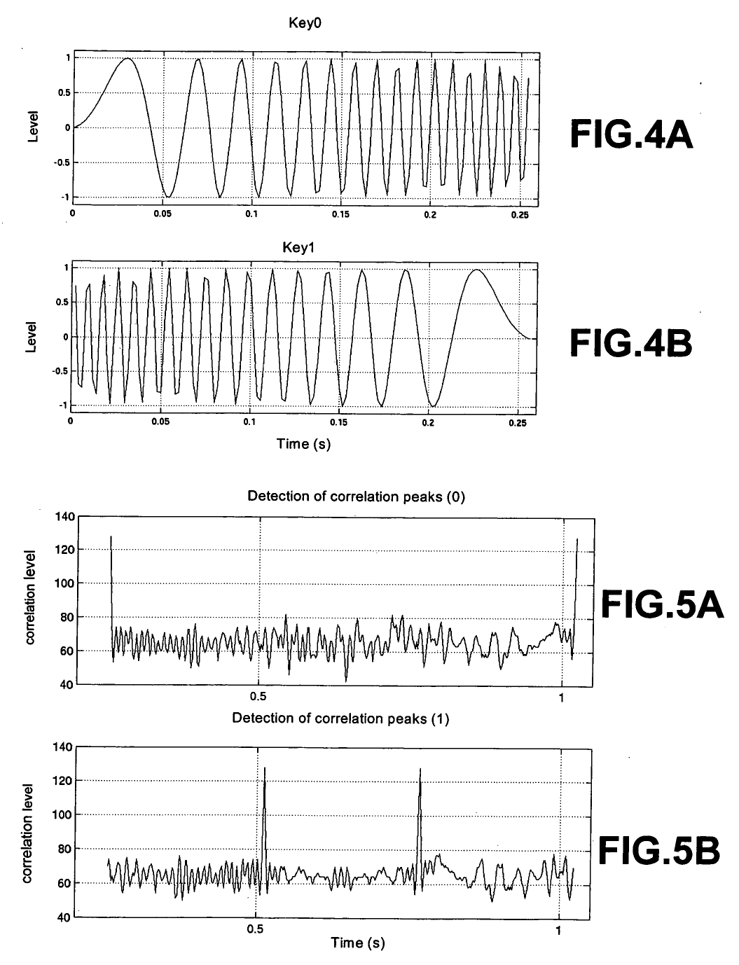

FIGS. 4A and 4B respectively show signals in baseband assigned to reference keys key0 and key1 used in the releasing signal; and

FIGS. 5A and 5B illustrate the detection of correlation peaks to respectively determine the bits with a value 0 and bits with a value 1 in a signal received by the hydrophone of the station.

An embodiment of an ocean-bottom seismic station according to the invention is shown in FIGS. 1 and 2. FIG. 1 provides a schematic view in cross-section of the station and FIG. 2 is a top view. The station, referenced 1, has a glass sphere 2 placed in a protection shell 3 made of plastic, a detachable ballast 4 attached to the protection shell by elastic cords 5, and a hydrophone 6 mounted on the exterior of the protection shell. The assembly formed by the protection shell 3+the sphere 2 has positive buoyancy and constitutes the part of the station to be retrieved on the surface after a measurement session.

The glass sphere 2 is hollow and capable of withstanding the hydrostatic pressure prevailing at the depths of use, namely depths of up to about 6,000 meters. It is constituted by two hemispheres with contiguous edges, joined together in setting up a vacuum inside the sphere. It contains a unit 7 to process the signals coming from the hydrophone 6 and, if necessary, the signals coming from the geophones 8 designed to detect the shear waves along three axes x, y and z, a flash light 9, a VHF transmitter 10 and rechargeable cells or batteries 11 designed to power all the electronic circuits of the station. All these circuits, except for the geophones and the flash light, are fixed to a supporting tray 12 attached within the sphere. This tray is positioned horizontally and bonded to the interior of the sphere. The flash light 9 is installed in the top part of the sphere, for example at the top of a pole fixed to the tray 12, and the geophones 8 are placed at the bottom of the sphere.

The unit 7 has the role of processing the seismic signal coming from the hydrophone 6 and the geophones 8, as well as the ballast-releasing acoustic signals picked up by the hydrophone. This processing shall be described in detail with reference to FIG. 3.

The flash light 9 and VHF transmitter 10, which is provided with an antenna 13 outside the sphere, are used to improve the locating of the seismic station when it is raised to the surface. Windows 14 are made for this purpose in the protection shell 3 to let through the light produced by the flash light 9. The flash light and the VHF transmitter are preferably put into operation when the station emerges from the surface of the water. They are turned on, for example, in response to a signal coming from a sensor detecting a sudden change in the pressure prevailing around the station.

In the exemplary embodiment of FIGS. 1 and 2, the elastic cords 5, whose role is to tie the ballast 4 to the protection shell 3, are of a sandow type or similar. They are three in number and are connected, by their lower end, to three points of the ballast 4 and, by their upper end, to a triangular metal ring 15 positioned on the top of the protection shell 3. When a release command is received by the station, an electrical current is sent through the ring which, when it makes contact with the water, breaks up by electrolysis and releases the ballast.

Furthermore, the sphere 2 is tightly sealed and provided with tightly sealed passages 16 for the different cables or connectors which, in particular, connect the unit 7 to the hydrophone 6 or to an external computer to retrieve the seismic data when the station is brought back to the vessel. One of the passages is also used to set up vacuum inside the sphere.

A functional diagram of the unit 7 and of the ballast-releasing device is proposed in FIG. 3. The unit comprises essentially an analog-digital converter 100 to produce digital samples of the signals coming from the hydrophone 6 and the geophones 8, a microprocessor 110 to process said digital samples and a memory 120, for example a compact flash type memory, to store the samples of the seismic signal. The unit 7 is preferably complemented by a high-precision clock circuit 130 that replaces the internal clock of the microprocessor to obtain seismic data with precise dating.

According to the invention, in addition to the seismic data to be stored in the memory 120, the microprocessor 110 delivers releasing commands activating the closure of a release switch 140. This switch is connected, firstly, to the positive terminal of the rechargeable batteries 11 and secondly to the triangular ring 15. When the microprocessor 110 delivers a release command, the switch 140 gets closed, thus triggering the passage of an electrical current through the triangular ring 15. The ring then breaks up by electrolysis and releases the ballast.

To augment the reliability of the ballast-releasing device, the rechargeable batteries 11 of the seismic station are preferably formed by two separate blocks, one designed to power the unit 7, and the other designed to power the ballast-releasing mechanism. If the voltage level of the block assigned to the unit 7 falls below a threshold of efficient operation of the unit, it is then planned to automatically activate the release of the ballast by the control of the switch 140. To improve the conditions of release of the ballast 4, it may also be planned to tauten the sandows 5 very forcefully against the protection shell 3 so as to optimize the release of the station at the time of the release.

A detailed description shall now be given of the release command and the operation of the unit 7. According to the invention, the unit 7 permanently listens for seismic waves and release commands. It thus accomplishes the normal acquisition of seismic data from signals coming from the hydrophone 6 and the geophones 8, and furthermore detects the presence of release commands in the signals coming from the hydrophone. If such a command is detected, it triggers the release of the ballast which keeps the station on the ocean bottom.

The release commands are acoustic waves produced by an acoustic transducer. It is indeed acoustic waves that are best propagated in the sea environment. To optimize the detection of the release commands by the unit 7, a low-frequency signal is preferable inasmuch as the seismic data acquisition chain of the unit is a low-frequency chain. However, to meet the constraints of the emission of a signal from the surface to depths that may reach several thousands of meters, it is necessary to modulate this low-frequency signal by a carrier signal of higher frequency, for example by a signal having a frequency of 8 to 12 kHz.

The acoustic command sent is constituted by a succession of bits with a value 0 or 1. Preferably, a short sequence that can be easily repeated is chosen.

This command has, for example, 12 bits. There are then 212 combinations available, giving 4096 different codes, making it possible to obtain an individual release command for each station. It is thus possible, for a total population of 1000 stations, to manage four acoustic commands per station. All-purpose commands, other than the release command, may then be envisaged, for example to simultaneously trigger the start of the end of data acquisition for several stations.

Hereinafter in the description, the bits with a value 0 or 1 of the release command are called reference keys, and are respectively designated as key0 and key1. A particular elementary signal is associated with each of these reference keys. To enable the unmistakable recognition of these elementary signals, it is necessary to choose a signal that cannot be found in natural conditions or in marine-related activities (such as measurements, transmissions, shipping noise etc). These elementary signals are, for example, acoustic signals linearly modulated between two frequencies f1 and f2 as shown in FIGS. 4A and 4B. In these examples, the key 0 is a frequency-modulated signal whose frequency varies linearly from the frequency f1 to the frequency f2, with f2>f1. Conversely, the key 1 is a frequency-modulated signal whose frequency varies linearly from the frequency f2 to the frequency f1. The duration of the elementary signals is, for example, fixed at 0.256 seconds.

The generation of the release command consists for example in generating a signal representing a 12-bit code comprising 0s and 1s and in modulating the signal obtained by a carrier signal in the 8-12 KHz band. The release command signal is therefore constituted by 12 consecutive elementary signals modulated by a high-frequency carrier signal. The duration of the release signal is equal, for example, to 3.072 seconds. This signal is transmitted to the seismic station at the end of the measurements session.

On the reception side, the seismic station is responsible for detecting this release command signal. This detection is done by the unit 7 which performs the following steps: sampling, binarization, storage in a shift register, correlation with the reference keys, detection of correlation peaks and command detection.

In the unit 7, the signal received by the hydrophone 6 and the geophones 8 is first of all sampled with a frequency of 500 Hz for example. This sampling, like the rest of the operations of the unit 7, may be managed from a software viewpoint by an interruption procedure prompted every two ms by a periodic switch controller of the microprocessor 110. This sampling frequency is chosen so that it does not activate the working of the microprocessor 110. For a microprocessor working at 20 MHz, we have chosen a sampling frequency of 500 Hz through which consumption by the unit 7 is not drastically increased.

The samples are then binarized so as not to take account of the amplitude of the signal and so as to simplify the operation of digital correlation that will follow. Through this operation, only the sign information of the sample is kept: 1 if the value of the sample is positive, 0 if it is negative, or vice versa.

The binarized samples (0 or 1) are stored in a shift register of the microprocessor having a depth of 128 bits for example. The values of this register are shifted leftward every 2 ms. A new sample is thus recorded every 2 ms in the cell of the register furthest to the right. A new code of 128 samples therefore appears in the shift register every 2 ms. Thus, every 2 ms, a digital correlation is made between the 128 samples of this code and the 128 samples of the keys key0 and key1 sampled beforehand. This digital correlation is done through an XOR type operation as follows:

$$Correlation\_key0 = {\sum }_{N = 1}^{128} sample [ N ] XOR key 0 [ N ]$$

$$Correlation\_key1 = {\sum }_{N = 1}^{128} sample [ N ] XOR key 1 [ N ]$$

Through these computations, two levels Correlation_key0 and Correlation_key1 are obtained with a value ranging from 0 to 128, proportional to the correlation between the code recorded in the shift register and the keys key0 or key1.

In theory, if the code recorded in the shift register is identical to one of the reference keys, one of the values Correlation_key0 or Correlation_key1 will be equal to 128. In practice, given the noise, the multiple paths, the Doppler effect and the non-synchronization of the clocks between the transmitter and the seismic station, a smaller value will be obtained.

Thus, two correlation levels (Correlation_key0 and Correlation_key1) are obtained every 2 ms. These two correlation levels can be represented graphically as a function of time as illustrated in FIGS. 5A and 5B. In FIG. 5A, the correlation peaks correspond to the presence of bits with a value 0 in the signal received by the hydrophone and, in FIG. 5B, to bits with a value 1. These peaks are detected by comparison with a reference threshold, equal for example to 100.

If the microprocessor detects a correlation peak higher than the reference threshold every 0.256 s and if these correlation peaks correspond to the 12-bit sequence of the release signal, then it delivers a release command addressed to the releasing mechanism to release the ballast.

In conclusion, the seismic station as described here above has the following advantages:
low space requirement owing to the merging of the data-acquisition and release-control functions;
reduced construction cost;
the possibility of recharging the batteries, resetting the data-acquisition unit and transferring the seismic data to an external computer, for example by a serial link, without opening the sphere;
low operating cost.

As possible improvements, it could be envisaged to perform a compression of the data before storing it in the memory 120.

Although only one embodiment has been described, it goes without saying that any modification or change, made in the same spirit by those skilled in the art, relating for example to the shape of the protection shell or to the ballast-releasing mechanism, would not go beyond the scope of the invention.

1) A ocean-bottom station designed to perform in situ measurements, comprising a support structure with positive buoyancy with which there is associated at least one detachable ballast to convey said support structure to the bottom of the ocean for the period of a measurement session, the support structure including at least one hydrophone, one data acquisition unit to record measurement data and one device for the releasing of said detachable ballast,
the data acquisition unit being furthermore capable of controlling the releasing device in response to an acoustic release command received by the hydrophone.

2) A station according to claim 1, the release command being a low-frequency acoustic signal modulated by a carrier signal having a frequency of 8 to 12 KHz.

3) A station according to claim 2, said low-frequency acoustic signal being individualized to the station.

4) A station according to claim 1, said low-frequency acoustic signal comprising a plurality of consecutive elementary signals of a first type and of a second type representing a sequence of bits individual to said seismic station, the elementary signals of the first type and of the second type respectively representing bits with a value 0 and bits with a value 1, or vice versa.

5) A station according to claim 4, the elementary signals of the first type being signals that are linearly modulated in frequency from the frequency f1 to the frequency f2, with f2>f1, and the elementary signals of the second type being signals linearly modulated in frequency from the frequency f2 to the frequency f1, or vice versa.

6) A station according to claim 1, wherein the data-acquisition unit comprising means to sample said received signal and detection means to detect the presence of the low-frequency signal in the sampled signal by digital correlation and deliver a release command to the releasing mechanism if said low-frequency signal is detected, whereby said release command is detected by the hydrophone.

7) A station according to claim 1, the support structure of the station being constituted by a spherical glass enclosure placed inside a protection shell, said spherical enclosure being resistant to the hydrostatic pressure present at depths that may go up to several thousands of meters.

8) A station according to claim 7, further comprising a signal light placed inside said spherical enclosure to produce light when the support structure is raised to the surface after the releasing of the ballast, the protection shell being given apertures to let through the light produced by said signal light.

9) A station according to claim 1, the ballast being attached to the support structure by elastic cords that are fixed, by a first end, to said ballast and, by a second end, to a metal ring destructible by electrolysis.

10) A station according to claim 9, the releasing mechanism comprising a switch controlled by the detection means of the data acquisition unit, said switch making an electrical current pass into the metal ring to destroy it when it receives a release command.
